(19) United States
(12) Patent Application Publication
(10) Pub. No.: US 2008/0314098 A1
(43) Pub. Date: Dec. 25, 2008

(54) System for Enhanced Security of Passengers for Boarding a Means of Transport

(75) Inventor: Franklin Devaux, Prenois (FR)

Correspondence Address: YOUNG & THOMPSON, 209 Madison Street, Suite 500, ALEXANDRIA, VA, 22314, US

(73) Assignee: Ellen Investments Ltd, Road Town (VG)

(21) Appl. No.: 11/660,501

(22) PCT Filed: Aug. 18, 2005
(86) PCT No.: PCT/FR2005/002081

§ 371 Date: Feb. 20, 2007

(30) Foreign Application Priority Data
Aug. 17, 2004 (FR) 0408925

(51) Int. Cl. E05B 65/00

(52) U.S. Cl. 70/262

(57) ABSTRACT

A system for the security of passengers boarding a transport unit such as an aircraft or any other land or water transport unit, the boarding being carried out inside a single secure site having at least one access element equipped with control elements, enabling those concerned by the transport, namely the passengers and the administrative, technical and crew personnel to be securely identified, the secure site being equipped with one or more of the control elements, arranged at strategic locations, enabling the involved persons to be followed from the time of their access to the secure site until their boarding the transport unit, as long as the transport unit is not moving. The secure site is equipped with at least one secure opening enabling at least part of the transport unit to be introduced into the secure site including the access to the transport unit.

This present invention concerns a system designed to solve the problem of passenger security when embarking onto a means of transport of the aircraft type or any other means of transport, whether terrestrial or nautical.

At the present time, terrorist activities represent a considerable danger in the area of public transport and it appears essential, for passenger security, to be able to prevent entry into the means of transport and/or the embarkation area by ill-intentioned individuals.

A real demand is currently emerging on the part of the users of public transport, in particular of the aircraft type, to increase the level of security during embarkation and during the transportation itself. Failing this, then in the years to come, a large decrease in the use of such transportation resources is likely to occur, with the consequent considerable damaging financial repercussions on the carrier companies, and the air carriers in particular.

One is already familiar with systems that aim to allow individual access checks at the airport. This is the case, for example, of English patent GB 2 382 907 concerning a system for individual access checks at an airport that includes a card containing information, such as biometric characteristics for example, which can be read by an access control machine. By means of a processor, this machine compares this information with information obtained in real time from the user. The processor allows or refuses access after the user has entered a number that only he knows.

In fact, the access card can include the characteristics of the status of the user (passenger, employee, hierarchy level, etc.), this determining the areas to which access is authorised inside the airport. However, the current configuration of the places of embarkation into a means of transport, in particular of the aircraft type, is such that the locations where access control is necessary are widely separated from each other, and spreading even into the very area of the overall space devoted to boarding. This multiplicity of checkpoints greatly increases the risk of intrusion by people who are not authorised to enter or who are liable to adversely affect the security of those boarding the means of transport, namely the passengers and the administrative and technical staff and the cabin crews.

In addition, the passage from a place where access control is essential to another is frequently through areas where security is less so, or even zero. It is in these free-access zones, and as a consequence with very limited security, that all of the public areas other than those devoted to the boarding itself are located, such as waiting areas, toilets or baggage handling arrangements. Thus, it appears obvious that the security and safety of users of the means of transport is very limited inside these zones. In these circumstances, any individual is able to steal the identity of one of the travellers or workers, and it appears possible that a person desiring to execute a terrorist act or any other action could enter the aircraft during maintenance or servicing activities on the aircraft, prior to its next take-off, and could damage the aircraft or remain inside it. In the same vein, the aircraft is immobilised in a parking area inside the terminal area, where it will remain until its next flight. During all of the maintenance, provisioning, loading and servicing operations, the aircraft remains accessible from outside the terminal. It is therefore possible that a terrorist or a clandestine passenger will be able to enter via one of the access points of the aircraft, such as the baggage hold.

One is familiar with international patent application WO-A-02/27686, which describes a system for the security of passengers intending to board an aircraft, where the said boarding takes place in a secure space that has access resources which are equipped with control resources used to identify the people concerned in using the means of transport, where the said space is equipped with additional control resources positioned at strategic points that allow the monitoring of those concerned from their entry into the secure space until they board their aircraft.

This system, which is described in document WO-A-02/27686, does not prevent access on board the said aircraft from outside of the secure area.

One of the aims of the invention is therefore to overcome these drawbacks by proposing a system that can be used to solve the problem of passenger security, when embarking onto a means of transport of the aircraft type, or any other terrestrial or nautical means of transport in which all the operations relating to boarding occur inside a completely secure perimeter forming a single secured space, preventing any access on board the means of transport without having been checked beforehand.

To this end, and according to the invention, a system is proposed for the security of passengers, when boarding a means of transport of the aircraft type or any other terrestrial or nautical means of transport, where the said boarding takes place inside a single secured space with at least one access resource that is equipped with control resources used to identify, with certainty, the users of the means of transport, namely the passengers and the administrative and technical staff and the cabin crews, with the said secured space being equipped with one or more of the said control resources, placed at strategic locations, and used to monitor the said users from their entry into the said secured space up to boarding the said means of transport, for as long as the said means of transport remains immobile, the said secured space being notable in that it is equipped with at least one secured opening that is used for the introduction within the said secured space of at least one part of the means of transport that includes at least one access point to the said means of transport, the said secure opening being composed of closure resources that are matched to the dimensions of the said means of transport, thus eliminating any possibility of entering or leaving the secure space via the said secure opening.

It can be seen clearly that, in contrast to previous design, the system according to the invention can be used advantageously to greatly reduce the risks of illicit entry of any person liable to compromise the security of users of the means of transport, in particular of the passengers, by achieving a centralisation of all operations relating to boarding of the said passengers onto a means of transport, these operations being centralised within a single secured space with a reduced number of access resources, each of these being equipped with control resources used to identify, with certainty, all of the people who are authorised to enter the said space and in particular the passengers intending to board the said means of transport.

Furthermore, the determination of a single and sufficiently large secured space can be used advantageously to incorporate all of the so-called public facilities in which security is reduced or is zero, such as toilets, waiting areas, baggage handling areas, etc., so that all of the boarding operations can take advantage of the total security provided by the secured space, with the peace of mind that this entails, and as a consequence, the undoubted wellbeing of the users of the means of transport.

Also benefiting from centralisation of the operations inside a single secured space, the servicing and maintenance operations on the means of transport are effected within the said secured space, so that these operations can be rendered completely reliable, in terms of terrorist risks in particular, since they are then carried out in areas that are secured by security staff, and free of all suspicion.

Other advantages and characteristics will appear more clearly from the description that follows of one example of implementation of the system for the security of passengers when boarding a means of transport, with reference to the appended drawings in which:

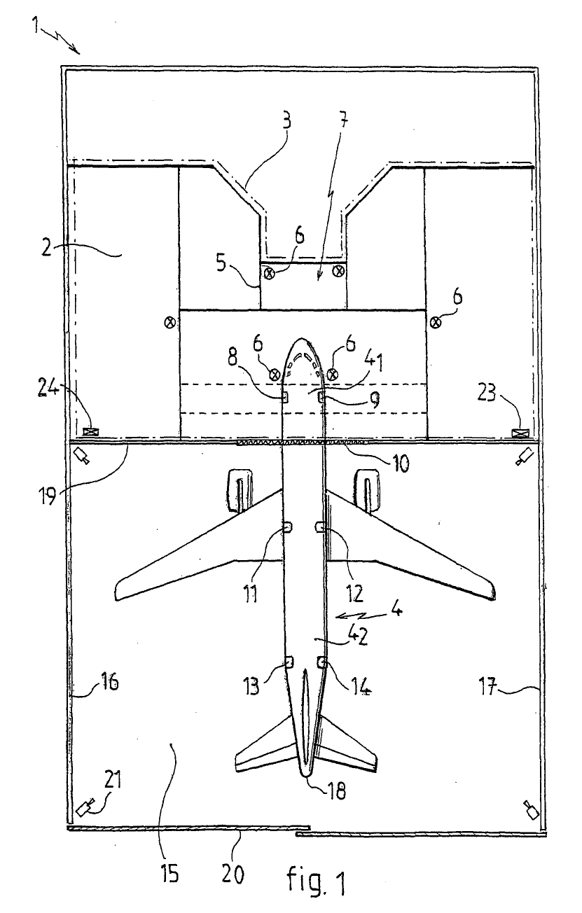

FIG. 1 is a schematic plan view of a particular example of the system according to the invention.

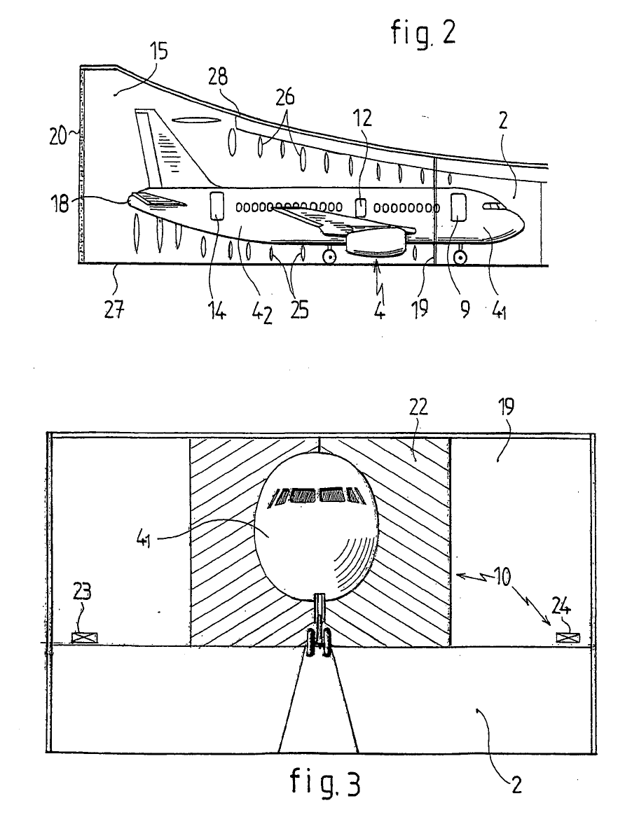

FIG. 2 is a side view of one part of the system according to the invention,

FIG. 3 is a front view of a part of the system according to the invention.

Referring to FIG. 1, the system 1 according to the invention is composed of a space 2 bordered by a perimeter 3 forming an impregnable barrier to any person who has not been checked. Thus, the presence within the said space 2 of any undesirable individual is impossible, thereby conferring upon the said space 2 the optimal security currently demanded by users of the means of transport, and more generally all those boarding the means of transport, namely in addition to the administrative, technical and cabin staff.

The means of transport in question, which will be used in the remainder of the description in order to describe the subject of this present invention will be an aircraft 4. However, the invention remains applicable to any other means of transport, whether nautical or terrestrial.

This secured space 2 has the particular quality of unity of space, so that the options for illicit entry are undeniably restricted in comparison to the known configurations in places at which access points that are strictly controlled in order to make them secure are many and widely separated from each other.

The single space 2 therefore has as its essential objective to constitute a highly secure interface between the external environment and the means of transport 4, access to which will then be authorised only to the those users who have received prior authority to enter the said secured space 2. In this regard, the secured space 2 has at least one access resource 5 that is equipped with control resources 6 which are used to identify, with certainty, those boarding the means of transport.

According to another characteristic of the invention, the access resource 5 to the secured space 2 is a room 7 of the airlock type which allows the presence of only one person at a time. At least one control resource 6 is installed within the said room 7, and only those people who have been identified, with certainty, by the said control resource 6 are allowed to pass through this room 7.

In a particularly advantageous manner, one or more control resources 6 are placed at strategic locations inside the secured space 2 so that users of the means of transport are monitored throughout their movements and their activities from their entry into the secured space 2 until they leave it or board the aircraft 4, for as long as the latter remains immobile.

According to one essential characteristic of the invention, one of the control resources 6 is positioned at the access resource 8, 9 to the aircraft 4 in order provide an additional guarantee that no person whose presence inside the aircraft 4 is undesirable is able to board in the situation where one of the control resources 6 may turn out to be defective or temporarily malfunctioning.

According to the invention, the control resources 6 allow access only to those people who have been identified beforehand, and whose authorisation to enter is determined in accordance with precise and rigorous criteria. These people are then registered according to these criteria, which are stored rigorously in a database.

More specifically, the control resources 6 consist of an interactive terminal that is capable of retrieving information from a stored data medium in accordance with identification criteria and/or obtained from the person to be identified. With the objective of raising the level of security, this information can essentially be of the biometric type. After analysis of this information, the control resources 6 do or do not identify the person concerned, which should then be one of the people that has been identified beforehand prior to authorising access.

According to a variant of the invention, the data medium consists of a personal card that has at least one electronic chip that includes a personal identification algorithm. Furthermore, the personal card can include an antenna of the emitting and/or receiving type, to enable all of the already-known types of application as well as a CD-ROM or any other resource that is used for the compilation of information that can be decrypted by means of special software executed by computer, for example. The personal card can also be used to perform anonymous operations, providing its owner with assured confidence and optimal security in certain transactions such as flight reservations, booking of hotels or vehicles, baggage arrangements, and even accessing the Internet in a secure manner inside the secured space 2 or on board the aircraft 4.

In a characteristic manner, identification of the owner of the data medium is effected at the control resource 6 by the use of a processor which, in a first stage, randomly selects one or more criteria from among the identification criteria stored on the data medium or in an associated database, these data being biometric in particular, and including photographs, fingerprints, iris analysis, the dynamic of signatures, voice recognition, ADN patterns, a barcode with at least eight characters, or any other data element characterising each individual personally. In a second stage, the processor compares the selected criteria with information determined in real time, and the moment of the identification, from the person to be identified, this information being collected by means of the interactive terminal.

The system according to the invention aims to solve the problem of passenger security when boarding an aircraft 4, and this security is achieved by the introduction of the front part 4₁ of the aircraft 4 into the secured space 2. The part 4₁ of the aircraft 4 introduced is such that it should include at least one access resource 8, 9 to the aircraft 4 in order to allow entry to the people who are authorised to board it from the interior of the said secured space 2. The introduction of the aircraft 4 inside the secured space 2 is effected through a secured opening 10 such that no living entity or hardware item other than the aircraft 4 is able to pass through it. This secured opening 10 will be described in greater detail below.

The other entrances 11, 12, 13 and 14 of the aircraft 4, which are not located in the secured space 2, in particular in the case of large scheduled passenger aircraft, are, for their part, located in a space which is not accessible from the outside of the terminal, in the form of a partitioned parking area 15 in which the rear part 4₂ of the aircraft 4 is located. This partitioned parking area 15 is bordered by the side walls 16 and 17 of the enclosure of the system 1 which extend beyond the rear end 18 of the aircraft 4, by the intermediate wall 19, which has the secured opening 10, and which separates the parking area 15 from the secured space 2, and by a closure arrangement 20 located at the rear extremities of the side walls 16 and 17, with the parking area 15 being covered by a roof whose shape is matched to that of the aircraft 4 seen in profile, as presented in FIG. 2.

The closure arrangement 20 will be composed, in a preferred and non-limiting method of implementation, of a barrier consisting of one or two large doors, of the grilled type for example, mounted either in a hinged manner or on slides, and preferably motor-driven. Its height will preferably be matched to that of the side walls 16 and 17 in order to guarantee total closure of the parking area 15 and to eliminate any possibility of scaling the barrier in order to enter the aircraft through entrances 11, 12, 13 and 14 located in the parking area 15. In a preferred and non-limiting method of implementation, the side walls 16 and 17 are of sufficient length to allow the total insertion of the aircraft 4 into the parking area 15, before introducing the front part 4₁ into the secured space 2. Thus, when the aircraft has fully entered into in this area 15, control resources, of the camera type 21 for example, check that no person is located in the parking area 15 prior to the activation of the closure arrangement 20. Then, when the zone 15 is partitioned off, and after a second check by the cameras 21 ensuring that no person has entered into the enclosure during closure of the zone 15, the aircraft is then allowed to enter via the secured opening 10 into the secured space 2. This access procedure guarantees that any person who is working on the aircraft will have been authorised beforehand to enter into the secured space 2 via the access resource 5, and then to enter into the aircraft 4 via the front part 4₁, where he will have been subjected to another identity check on entering and again on leaving the aircraft 4 by means of the control resources 6 installed at the access resource 8, 9 to the aircraft 4.

The secured opening 10 is constituted by the closure resources 22 which are matched to the dimensions of the aircraft and perfectly follow the wall of the cockpit, thus eliminating any possibility of entering or leaving the secured space 2 via the secured opening 10. The front part 4₁ of the aircraft, located in the secured space 2, is thus completely isolated from the outside in relation to the rear part 4₂ located in the parking area 15 which is partitioned off. In a preferred though non-limiting method of implementation, detection resources 23 and 24 will be positioned in the secured space 2, along the intermediate wall 19 in order to detect any attempt to break into the secured opening 10.

It is thus guaranteed that no person can enter the aircraft 4 via the rear part 4₂ and that all the people engaged on maintenance or servicing work, etc., are channelled, and enter the aircraft 4 after their identity has been checked by the control resources 6 located at the access resource 8, 9, where these control resources 6 check that all the people who entered have also in fact left. If this is not the case, then those staff members who have not been checked out are then necessarily either in the aircraft or in the parking area 15 that is partitioned off, since any attempt at entry to the secured space 2 from the parking area 15 via the secured opening 10 is detectable by means of the detection resources 23, 24.

For example, it is possible to design closure resources 22 composed of several curtains, in either soft or stiff material, with each curtain being matched precisely to the dimensions and shapes of the cockpit of the aircraft, as a function of the model that can be accommodated in the secured space 2. As an example, the curtains can be fitted on a slide along the intermediate wall 19 and drawn vertically in relation to the cockpit of the aircraft until they enclose it and thereby neutralise the secured space 2 entirely in relation to the parking area 15. The detection resources 23 and 24 can, for example, be presence detectors such as the beam-crossing sensors positioned at the lateral extremities of the intermediate wall 19, with the light beams being interrupted when a person attempts to pass through the curtain when thus positioned, in this case alerting the security service of the carrier company occupying the enclosure of the system 1.

In a preferred though non-limiting method of implementation, the system 1 is equipped with a cleaning and defrosting device 25 and 26 to maintain a high level of cleanliness of the aircraft 4 and to maximise the brand image of the carrier company occupying the secure enclosure, and in particular during the winter periods, especially allows the aircraft to be defrosted just before it departs for take-off. Thus, during the boarding of the passengers, who enter the aircraft via the access resource 8 and 9 of the gangway type, located in the secured space 2 where they are subject to the control resources 6, the cleaning and defrosting device 25 and 26 makes the aircraft operational, and ready to take off immediately after it leaves the parking area 15 which occurs after opening the

1. A system (1) for the security of passengers when boarding a means of transport (4) of the aircraft type or any other terrestrial or nautical means of transport, where the said boarding takes place inside a single secured space (2), characterised in that the said secured space (2) has at least one access resource (5) equipped with control resources (6), used to identify, with certainty, users of the means of transport, namely the passengers and the administrative, technical and flying personnel, where the said secured space (2) is equipped with one or more of the said control resources (6), placed at strategic locations, and used to monitor the said users from their entry to the said secured space (2) up to boarding the said means of transport (4), for as long as the said means of transport (4) remains immobile, the said secured space (2) being equipped with at least one secured opening (10) that is used for the introduction within the said secured space (2) of at least one part (41) of the means of transport (4), which includes entry (8, 9) into the said means of transport (4).

2. A system (1) according to claim 1, characterised in that the said control resources (6) allow access only to those people who have been identified beforehand and registered in accordance with criteria stored in a database.

3. A system (1) according to claim 1, characterised in that one of the said closure arrangement 20. The risks of a terrorist attack on the aircraft when the latter is accessible from the exterior of the terminal is therefore limited.
In a preferred though non-limiting method of implementation, the cleaning and defrosting device 25 and 26 is composed of sprinkler devices located low down near the floor 27 and high up under the roof 28, as represented in FIG. 2. For example, it is possible to conceive of an upper telescopic arrangement positioned below the roof 28, and which is deployed so that it follows the shape of the aircraft as seen from above, and in particular at the wings, and a telescopic lower arrangement positioned near the floor 27 which is deployed so that it too matched the shape of the aircraft as seen from below. These sprinkler arrangements will be composed, for example, of two types of nozzle, the first type being the nozzles designed to spray the cleaning products and the second being the type of nozzles that dispense the defrosting substance. Depending on the season, the system will be able to effect the cleaning and the defrosting of the aircraft 4 either simultaneously or separately.
Various changes can naturally be made by a professional engineer to the system that has just been described purely by way of a non-limiting example, without going outside the scope of the invention.
For example, without leaving the scope of this present invention, it is possible to envisage that the system 1 which includes a secured space can be designed to accommodate the totality of the means of transport 4. In this particular case, the parking area 15 would then be incorporated into the secured space 2, and the opening 10 would be placed at the rear end of the parking area 15. control resources (6) is positioned at the access resource (8, 9) to the said means of transport (4).

4. A system (1) according to claim 1, characterised in that the said control resources (6) consist of an interactive terminal that is capable of retrieving information, in particular biometric information, from a data medium in which the data are stored in accordance with identification criteria and/or obtained from the person to be identified, in order to effect the identification of the owner of the said data medium, and to authorise entry or otherwise.

5. A System (1) according to claim 4, characterised in that the said data medium consists of a personal card which has at least one electronic chip containing a personal algorithm for the identification of its owner, with an antenna and a CD-Rom or any other resource that is used for the compilation of information that is intended to be decrypted by means of special software executed by computer.

6. A system (1) according to claim 4, characterised in that the said identification is effected by means of a processor which, in a first stage, randomly selects one or more criteria from amongst the said identification criteria stored on the said data medium or in an associated database, in particular biometric data such as photographs, fingerprints, iris analysis, the dynamics of a signature, voice recognition, ADN patterns, barcodes with at least 8 characters or any other data element identifying each individual personally, and then which compares the said selected criteria with information determined in real time at the moment of the identification, from the person to be identified at the resource of the said interactive terminal.

7. A system (1) according to claim 1, characterised in that the access resource (5) to the said secured space (2) is a room (7) of the airlock type, in which the control resource (6) used to identify, with certainty, users of the means of transport, is operated, and where the said room (7) allows the presence of only one person at a time.

8. A system (1) according to claim 1, characterised in that the front part (4₁) of the means of transport (4) is introduced into the secure enclosure (2) via the secured opening (10), and isolated from the rear part (4₂) of the means of transport (4) by the secured opening (10), with the rear part (4₂) being partitioned off by a closure arrangement (20) in a parking area (15) that is inaccessible from the outside the enclosure of the system (1).

9. A system (1) according to claim 1, characterised in that the secured opening (10) is composed of closure resources (22), matched to the model of the means of transport (4), and of detection resources (23, 24) used to detect any attempt to break into the said secured opening (10).

10. A system (1) according to claim 1, characterised in that it includes a cleaning and defrosting arrangement (25, 26) used to render the means of transport (4) operational for departure immediately after opening of the parking area (15).

11. A system (1) according to claim 2, characterised in that one of the said control resources (6) is positioned at the access resource (8, 9) to the said means of transport (4).
